(19) United States
(12) Patent Application Publication
(10) Pub. No.: US 2008/0206711 A1
(43) Pub. Date: Aug. 28, 2008

(54) Integrated Dental Abutment Block

(75) Inventor: Vincent J. Morgan, Boston, MA (US)

Correspondence Address: FISH & RICHARDSON PC, P.O. BOX 1022, MINNEAPOLIS, MN, 55440-1022, US

(73) Assignee: DEBBIE, LLC, Jamaica Plain, MA (US)

(21) Appl. No.: 12/035,712

(22) Filed: Feb. 22, 2008

Related U.S. Application Data
(60) Provisional application No. 60/902,626, filed on Feb. 22, 2007.

(51) Int. Cl. A61C 8/00

(52) U.S. Cl. 433/174

(57) ABSTRACT

An integrated abutment block has an abutment with an internal portion imbedded in the block and a depending post.

### CROSS-REFERENCE TO RELATED APPLICATION

This application claims the benefit of and incorporates by reference Provisional Application Ser. No. 60/902,626 filed Feb. 22, 2007 of Vincent J. Morgan entitled INTEGRATED DENTAL ABUTMENT BLOCK.

This present invention relates in general to dental implants, and more particularly to an integrated dental abutment block.

### BACKGROUND OF THE INVENTION

For background, reference is made to U.S. Pat. No. 5,827,062.

### BRIEF SUMMARY OF THE INVENTION

It is an object of the invention to provide an improved dental implant and method of implanting.

According to the invention, an integrated abutment block has an abutment with an internal portion and a depending post. The internal portion is seated within the block with the post extending below the block constructed and arranged to be seated in a root member implanted in a patient. The block may be generally tooth-shaped.

A method of implanting a prosthetic tooth includes milling an integrated abutment block having an embedded abutment internal portion and a depending post into the form of a tooth, and seating the post in an implanted root member.

Other features, objects and advantages of the invention will become apparent from the following detailed description when read with reference to the accompany drawing in which:

### BRIEF DESCRIPTION OF THE SEVERAL VIEWS OF THE DRAWING

FIG. 1 is a front view of an embodiment of the invention:

FIG. 2 is a perspective view of the embodiment of FIG. 1 illustrating the underside;

FIG. 3 is a diagrammatic view of the integrated abutment block of FIGS. 1 and 2 helpful in understanding the relationship of composite material to the abutment; and

FIG. 4 is a perspective view of an integrated dental abutment prosthesis.

### DETAILED DESCRIPTION

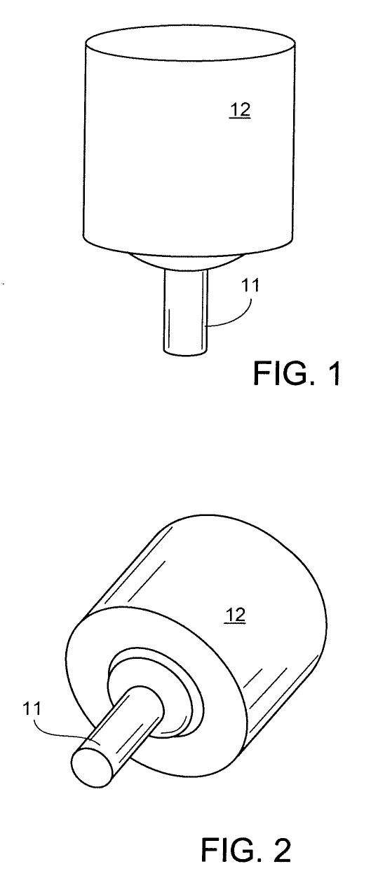

With reference now to the drawing and more particularly FIGS. 1 and 2, there are shown front and perspective views of an embodiment of the invention. An abutment 11 is seated in a block 12 ready for reduction, as by milling, into a final crown having a selected morphology. The abutment may then be seated in a root member that is implanted in a patient in accordance with well know techniques.

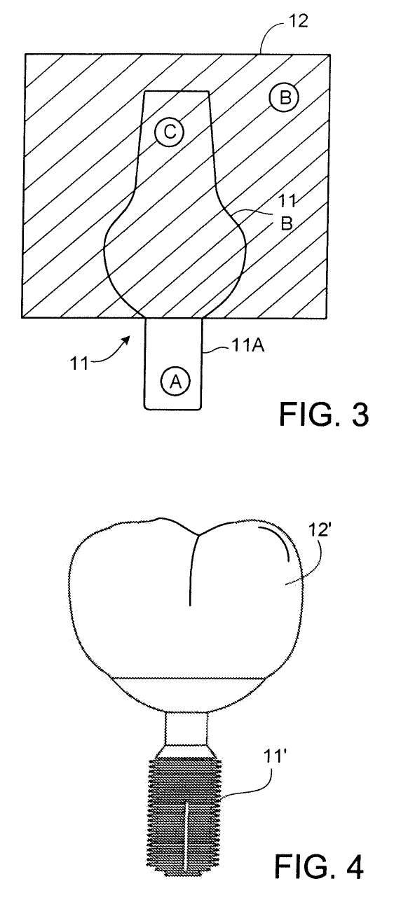

Referring to FIG. 3, there is shown a diagrammatic representation helpful in understanding the structural relationship among the different elements. Abutment 11 is shown seated in the block 12. Block 12 is typically of composite material and/or ceramic including zirconia and aluminum oxide or other suitable materials. The block may then be milled manually or with an automated process to form the final crown or coping. The shading of the material may be adjusted to achieve preferred aesthetics. The block may also be generally tooth-shaped as shown in FIG. 4.

Abutment 11 is formed with a depending post 11A that is typically made of titanium or other material including zirconia. Post 11A may include a locking taper connection or other suitable connection for seating within a root member that is implanted in a patient. Abutment 11 may include an embedded portion 11B embedded within block 12 that may also be of titanium or other suitable material including zirconia.

Referring to FIG. 4, there is shown a perspective view of an embodiment in which the block 12′ is generally tooth-shaped with depending post 11′.

The invention is advantageous in providing an integrated dental abutment block that may be seated in the implanted root member, preferably after being milled to form a prosthesis corresponding substantially to the tooth that was replaced.

There has been described novel apparatus and techniques for an integrated dental abutment block. It is evident that those skilled in the art may now make numerous uses and modifications of the apparatus and techniques herein disclosed without departing from the inventive concepts. Consequently, the invention is to be construed as embracing each and every novel concept and novel combination of concepts disclosed herein and limited only by the spirit and scope of the pending claims.

What is claimed is:

1. An integrated abutment block having an abutment with an internal portion and a depending post,
the internal portion being seated within the block and the post extending below the block constructed and arranged to be seated in a root member implanted in a patient.

2. An integrated abutment block in accordance with claim 1 where the block is generally tooth-shaped.

3. A method of implanting a prosthetic tooth including,
milling an integrated abutment block having an embedded abutment internal portion and a depending post into the form of a tooth, and seating the post in an implanted root member.
